(19) United States
(12) Patent Application Publication
(10) Pub. No.: US 2025/0055187 A1
(43) Pub. Date: Feb. 13, 2025

(54) MATRIX CIRCUITS AND BETTER BEAM CHARACTERISTICS FROM MBFN PRODUCED BEAMS

(71) Applicant: GALTRONICS USA, INC., TEMPE, AZ (US)

(72) Inventors: Sadegh FARZANEH, Kanata (CA); Behnam Zarghooni, Kanata (CA); Alireza Gharaati Jahromi, Kanata (CA); Mohammadmahdi Farahani, Kanata (CA); Azita Goudarzi, Kanata (CA); Zhihua Yu, Kanata (CA)

(73) Assignee: GALTRONICS USA, INC., TEMPE, AZ (US)

(21) Appl. No.: 18/799,226

(22) Filed: Aug. 9, 2024

Related U.S. Application Data
(60) Provisional application No. 63/518,941, filed on Aug. 11, 2023.
(60) Provisional application No. 63/578,823, filed on Aug. 25, 2023.

(51) Int. Cl. H01Q 3/26

(52) U.S. Cl. CPC H01Q 3/2694

(57) ABSTRACT

Systems and methods for mitigating beam squint and for producing better beam characteristics from MBFN (multi-beam forming network) generated beams. Matrix circuits are provided that operate as MBFNs where judicious assignment of input beams to specific rows in the matrix produce reduced or mitigated beam squint. As well, phase errors and other issues can be accounted for by adjustment of characteristics in the circuit elements that form the matrix circuit.

### CROSS REFERENCE TO RELATED APPLICATIONS

This application claims the benefit of and priority to U.S. Provisional Application No. 63/518,941, filed Aug. 11, 2023, entitled MITIGATING BEAM SQUINT IN MULTI-BEAM FORMING NETWORKS, and U.S. Provisional Application No. 63/578,823, filed Aug. 25, 2023, entitled IMPROVING BEAM SQUINT, SLL, AND BANDWIDTH IN A NOLEN MATRIX, the contents of each of these aforementioned applications are hereby incorporated by reference as if fully set forth herein.

### TECHNICAL FIELD

The present invention relates to antenna related circuitry. More specifically, the present invention relates to circuitry for use in producing beams with better characteristics using multi-beam forming networks.

### BACKGROUND

To increase the communication capacity of base stations, especially cellular base stations, multi-beam base station antenna arrays are required to divide the coverage of the base station from an entire area into several smaller cells. As well, it is expected to keep each beam's coverage to be the same within the whole operating frequency band. This beam coverage can become an issue especially with multi-beam antenna arrays.

Multi-beam antenna arrays can be divided into two categories: multi-beam antennas that are built based on lens principles, and multi-beam antennas that are formed from ordinary antenna arrays that are fed by multi-beam forming networks (MBFNs).

For lens-based antennas, such as Luneburg lens antennas, the multiple beams can be generated by multiple feeds located on different positions. These positions can be calculated using the principle of lens or paraboloid focuses, etc. Such multi-beam antennas generally have satisfying performances at wideband matching and beam isolation. As well, such lens-based antennas, theoretically, do not have problems of beam squint. However, lens-based antennas require large volume lens/reflectors that are heavy, expensive, and difficult/tricky to manufacture. The large size requirement for the lens/reflector stems from the requirement that the dimension of the lens must be greater than multiple electrical wavelengths. It is thus theoretically difficult to reduce the size of such reflectors, especially for lower frequencies such as 1 GHz-3 GHZ.

For antennas that are fed/generated by multi-beam forming networks (MBFNs), there are two sub-types of MBFNs. The first sub-type is again based on the lens principles and uses a lens such as a Rotman lens. Due to the similarity of the principles at work, this sub-type of MBFNs has the same advantages and drawbacks as the lens-based multibeam antennas, i.e., these provide satisfying performances but are physically quite large in size, and thus are often expensive and/or unsuitable for a given application.

The second sub-type of MBFNs is usually based on directional couplers, phase shifters, and crossovers. The features of the components only depend on the electrical lengths of the transmission lines to build the components. Since the components can be implemented using planar circuits, and since the sizes of the components can be reduced by using meander lines or high-dielectric laminates, the physical size of the networks is generally much smaller than lens-based multibeam antennas. However, almost all antenna systems, including those that use Butler matrices, Blass matrices, Nolen matrices, etc., that are generated by MBFNs have the problem of beam squint as well as phase errors.

Beam squint refers to the phenomenon wherein beam direction scans undesirably but inevitably with frequency changing. As the frequency changes, the beam direction (i.e., the direction of the signal in the azimuthal direction) will change, although the beam would preferably maintain a constant direction. Beam squint is especially problematic where, as for some communication systems such as 3G, 4G, and 5G mobile communications, up-link and down-link are operated at different frequency bands. Due to beam squint, the areas of beam coverage will be different at various frequencies (i.e., the areas of beam coverage will be different for up-link and down-link), meaning that the antenna array is unable to achieve closed-loop communication. This problem is exacerbated as the fractional bandwidth increases, for example, wider than 30% bandwidth.

There is therefore a need for methods and systems that address the issue of beam squint in such MBFN-generated antenna systems. Preferably, such methods and systems also produce better beam characteristics from such MBFN-produced beams.

### SUMMARY

The present invention provides systems and methods for mitigating beam squint and for producing better beam characteristics from MBFN (multi-beam forming network) generated beams. Matrix circuits are provided that operate as MBFNs where judicious assignment of input beams to specific rows in the matrix produce reduced or mitigated beam squint. As well, phase errors are accounted for by judicious adjustment of characteristics in the circuit elements that form the matrix circuit.

In a first aspect, the present invention provides a matrix circuit for coupling a plurality of input signal beams to a plurality of output antennas in an antenna array, the matrix circuit comprising:
a matrix of couplers, horizontal phase delay lines, and vertical circuit element lines;
wherein said matrix is configured to form:
a plurality of rows of circuit elements, each row of circuit elements comprising couplers and horizontal phase delay lines, each row receiving an input signal beam and each row comprising couplers coupled in series with at least one horizontal delay line between each pair of adjacent couplers; and
a plurality of columns of circuit elements, each column of circuit elements comprising couplers and vertical circuit element lines, said couplers being coupled in series with at least one vertical circuit element line between each pair of adjacent couplers, each column being coupled between an output antenna and ground;
wherein
at least one column of circuit elements further comprises a load coupled between a coupler and ground;
an output of each column of circuit elements is received by an output antenna element;
said matrix circuit is for forming multiple output beams based on said input signal beams.

In a second aspect, the present invention provides a method for improving beam characteristics of beams produced by an antenna array fed by a multibeam forming network (MBFN), the method comprising:
a) providing a matrix circuit of rows and columns of circuit elements to operate as said multibeam forming network;
b) providing input signal beams to said matrix circuit such that specific input signal beams are assigned as input to specific rows of circuit elements in said matrix circuit;
c) executing at least one of:
   c1) assigning a specific input signal beam from said input signal beams to a specific row in said matrix circuit, said specific input signal beam having a lowest absolute value azimuth angle among said input signal beams and said specific row being a row most adjacent to ground;
   c2) configuring at least one specific column in said matrix circuit to compensate for errors in antenna outputs for said at least one specific column;
wherein said matrix circuit comprises:
a plurality of rows of circuit elements, each row of circuit elements comprising couplers and horizontal phase delay lines, each row receiving an input signal beam and each row comprising couplers coupled in series row-wise with at least one horizontal delay line between each pair of adjacent couplers; and
a plurality of columns of circuit elements, each column of circuit elements comprising couplers and vertical circuit element lines, said couplers being coupled in series column-wise with at least one vertical circuit element line between each pair of adjacent couplers, each column being coupled between an output antenna and ground.

In a third aspect, the present invention provides a circuit for use in simultaneously generating multiple beams using an antenna array having multiple antenna array elements, the circuit comprising: a matrix circuit comprising a plurality of couplers and delay lines, said matrix circuit being coupled between a plurality of loads and said antenna array; wherein each row of said matrix circuit comprises a plurality of couplers coupled in series row-wise, with each row-wise pair of couplers being joined by at least one delay line, each column of said matrix circuit comprises a plurality of couplers coupled in series column-wise, a bottom row of said matrix circuit is coupled to a plurality of matching loads such that each coupler of said bottom row is coupled column-wise between a matching load of said plurality of matching loads and a coupler of an immediately preceding row of said matrix circuit, said each row of said matrix circuit provides a distinct signal beam having a unique azimuth within a predetermined azimuth range, such that at least three distinct signal beams are provided by said antenna array, said at least three distinct signal beams comprising at least a negative-extreme-azimuth beam corresponding to a negative extreme of said azimuth range, a center azimuth beam corresponding to a center of said azimuth range, and a positive-extreme-azimuth beam corresponding to a positive extreme of said azimuth range, and said circuit is used to implement a method comprising providing said center azimuth beam with said bottom row of said matrix circuit.

In a further aspect, the present invention provides a method for mitigating beam squint in an antenna array having multiple antenna array elements, the method comprising: providing a center azimuth beam with a bottom row of a matrix circuit that is coupled between a plurality of loads and said antenna array, wherein said center azimuth beam corresponds to a center of an azimuth range over which said antenna array is operated.

Yet a further aspect of the present invention provides a method for compensating for errors in output beams from a multibeam forming network, the method comprising:
providing a matrix circuit for coupling a plurality of input signal beams to a plurality of output antennas, the matrix circuit comprising a matrix of directional couplers, horizontal phase delay lines, and vertical circuit element lines and wherein said matrix circuit includes a plurality of columns of circuit elements, each column of circuit elements comprising directional couplers and vertical circuit element lines, each column of circuit elements being coupled between an output antenna and a load;
determining a phase error at an input to an output antenna at one of said columns of circuit elements;
determining a phase shift that compensates for said phase error; and
providing vertical circuit element lines that provide said phase shift.

### BRIEF DESCRIPTION OF THE DRAWINGS

The embodiments of the present invention will now be described by reference to the following figures, in which identical reference numerals in different figures indicate identical elements and in which:

FIG. 1 is a diagram of a matrix circuit according to an aspect of the present invention;

FIGS. 2A to 4B show beam quality simulation results for a 3×7 matrix circuit according to conventional assignment methods and according to the assignment method herein;

FIGS. 5A to 7B show beam quality simulation results for a 9×20 matrix circuit according to conventional assignment methods and according to the assignment method herein;

FIG. 8 is a plot showing coupler phase difference against frequency;

FIGS. 9A to 9F show beam squint simulation results for a matrix circuit with and without phase compensation;

FIG. 10 is a block diagram of a conventional Nolen matrix;

FIG. 11 is a block diagram of a 3-beam input, 7-element Nolen matrix according to one aspect of the present invention;

FIG. 12A shows the phase of beam 2 produced using the circuit in FIG. 11 without phase compensation;

FIG. 12B shows the amplitude of beam 2 produced using the circuit in FIG. 11 without phase compensation;

FIG. 13A shows the phase of beam 2 at the input of the antenna elements (i.e. the output of the Nolen matrix in FIG. 11) with phase compensation;

FIG. 13B shows the amplitude of beam 2 at the input of the antenna elements (i.e. the output of the Nolen matrix in FIG. 11) with phase compensation;

FIG. 14A shows a comparison of beams using the phase compensation scheme and a conventional Nolen matrix with the beam at different azimuth angles;

FIG. 14B shows a comparison of beams using a reordered row scheme with a conventional row assignment scheme;

FIG. 15 shows a block diagram of a 3-beam input, 7-element output Nolen matrix configuration using phase shifter according to another aspect of the present invention;

FIG. 16A shows the phase of the middle beam from the circuit in FIG. 15 at the input of the antenna elements without compensation;

FIG. 16B shows the phase of the middle beam from the circuit in FIG. 15 at the input of the antenna elements with compensation;

FIG. 17 shows a comparison of beams at different azimuth angles for the aspect of the invention that uses phase shifters to compensate for phase errors and for a conventional Nolen matrix;

FIGS. 18A-18F illustrate a 12-element, 6-beam implementation of one aspect of the present invention showing a multilayer configuration of a matrix circuit; and

FIGS. 19 and 20 are flowcharts detailing differing methods according to different aspects of the present invention.

### DETAILED DESCRIPTION

It should be clear that the systems and methods of the present invention are applicable to various frequency ranges and various wireless technologies. For clarity, the various methods and systems of the present invention are applicable to various mobile/cellular technologies/applications including 2G, 3G, 4G, and 5G technologies. As well, it should be clear that the various systems and methods of the present invention are applicable to well-known cellular frequency bands such as 617-960 MHz, 1695-2690 MHz, 3300-4200 MHz, and 5150-5925 MHz.

In one aspect, the present invention provides a method for using circuitry that is used with antenna arrays to cancel beam squint in the resulting multiple beams, based on the assignment of different beams to different rows of a matrix circuit. In particular, for a set of beams over a given azimuth range, a “center beam” is conventionally provided by a center row of the matrix. In one aspect of the present invention, the center beam is assigned to the lowest row of the matrix. This reduces the fundamental degradation of the higher scan-angle beams that otherwise results from the array aperture at lower rows.

Regarding the theoretical underpinnings of this aspect of the present invention, to generate a beam with a specific direction tilted φ from the normal direction at a given frequency f0, the progressive phase difference, ΔPha, between adjacent elements should be (Equation 1):

$$Δ Pha = \frac{2 π \cdot {D}_{ele} sin φ}{{λ}_{0}} \qquad ( 1 )$$

where λ₀ is the wavelength in free space at frequency f₀.

It can be seen that, if the beam direction, q, is to be kept as a constant value within a particular frequency bandwidth, the phase difference has to be a linearly increasing value because of the linearly increasing λ0.

However, due to the principle of directionally coupling, almost all directional couplers, such as 3-dB 90-degree quadrature coupler, rat-race coupler, Magic-T, etc., are unable to provide the performance of linear increased (or reduced/decreased) phase differences between the coupled port and through port. Instead, the couplers will generate a constant phase difference between the coupled port and through port within a given bandwidth.

According to Equation (1), it is clear that the ΔPha is a constant value and that, when 20 linearly increases with frequency changing/increasing, the value of q will be accordingly tilted. This explains the presence of beam squint in MBFNs. Since all the second sub-type MBFNs are constructed based on directional couplers, the beam squint problem is inevitable if the linear phase differences cannot be generated.

In order to effectively cancel the beam squint, note that, in a matrix circuit structure, beam squint results from a combination of two factors:
(1) the phase-shift caused by the matrix circuit rows; and
(2) the azimuthal angle (i.e., direction) of the beams.

In other words, the beams that are at more extreme angles inherently have higher squint. For example, the beam pointing to zero degrees (i.e., without any azimuthal tilt) has inherently less squint compared to a beam located at +/−30°.

Again, the first factor is unavoidable because, as the signal travels from one row to the next, it undergoes a phase shift which plays an important role in maintaining the beam angle. But the beam squint resulting from the azimuthal angle of the beams can be mitigated by assigning the rows of the matrix to provide rows at specific angles.

In particular, in one example, the conventional Blass matrix design provides a plurality of beams across a given azimuth range (e.g., for a 3-row matrix, the azimuth range might be (−30°, 0°, +30°)). A beam pointing to an extreme (i.e., the farthest left, e.g., +30 in the example range, in which the positive extreme is at the left) is provided by the topmost row of the matrix; the beam pointing to the center of the range (e.g., 0) is provided by the center row of the matrix; and the beam pointing to the opposite extreme (i.e., the farthest right, e.g., −30 in the example range, in which the negative extreme is at the left) is provided by the bottom row of the matrix. As would be understood, either the positive or the negative extreme can be positioned at the top/bottom of the matrix in a conventional matrix.

However, because of its position on the lowest row, the negative-extreme beam in this conventional design will have the most loss and therefore the lowest gain, and thus a higher phase-shift. As it already has a high beam squint due the extremeness of its angle, as explained above, this low gain and high loss results in further beam squint and lower quality overall.

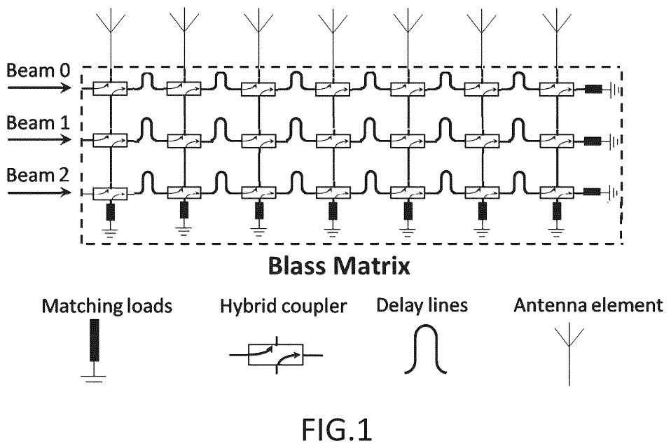

To address this beam squint issue, the center beam is assigned to the lowest row of the matrix, instead of the positive-extreme beam. The center beam, because it inherently has the highest directivity due to pointing to 0 azimuth, is less affected by the additional loss resulting from being positioned on the bottom row of the matrix, in comparison to the conventional extreme-azimuth beam assigned there. This configuration is shown in FIG. 1 as applied to a Blass matrix. As would be understood by the person skilled in the art, to observe a benefit from this configuration, the matrix circuit should have at least three rows. However, it should be noted that the azimuth range is not required to be symmetrical or centered at 0. Further, there is no requirement or preference for matrices with either an odd or an even number of rows. The person skilled in the art would understand how to apply the present disclosures to a particular desired implementation. As one non-limiting example, in an implementation using a matrix with an even number of rows, the bottom two rows of the matrix could correspond to the beam pair with the lowest absolute value and thus highest directivity.

It can be seen from FIG. 1 that the matrix circuit in FIG. 1 has at least one row that terminates in a matching load and that at least one column also terminates in a matching load. The various aspects of the present invention are applicable for matrix circuits that have at least one row that terminates in a matching load. Similarly, the various aspects of the present invention are applicable for matrix circuits that have at least one column that terminates in a matching load. As will be seen below, the various aspects of the invention are equally applicable to matrix circuits that do not have any rows that terminate in a matching load (e.g., a Nolen or a modified Nolen matrix circuit).

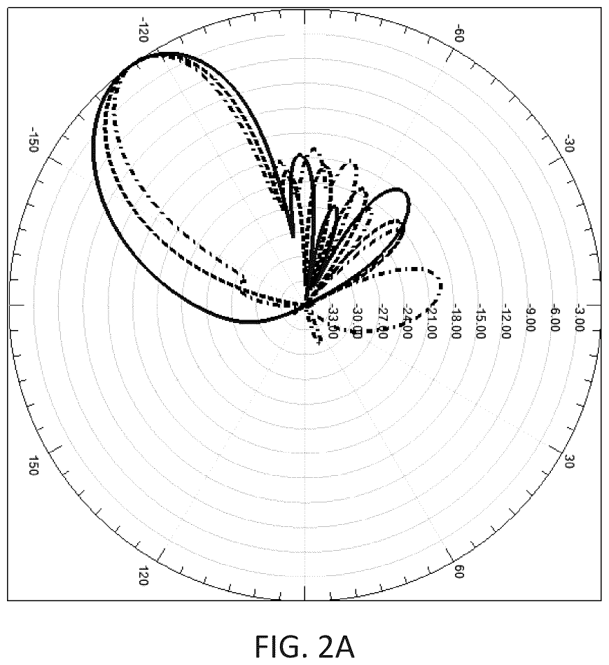

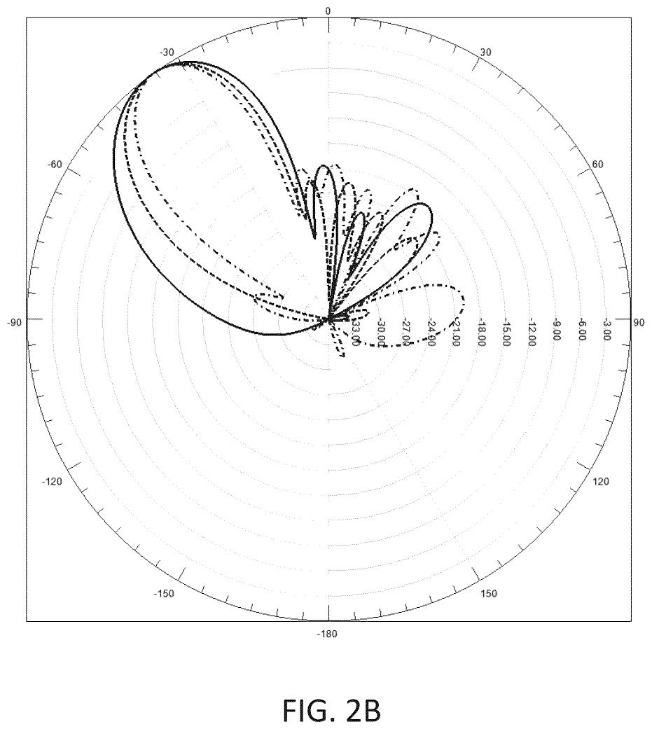

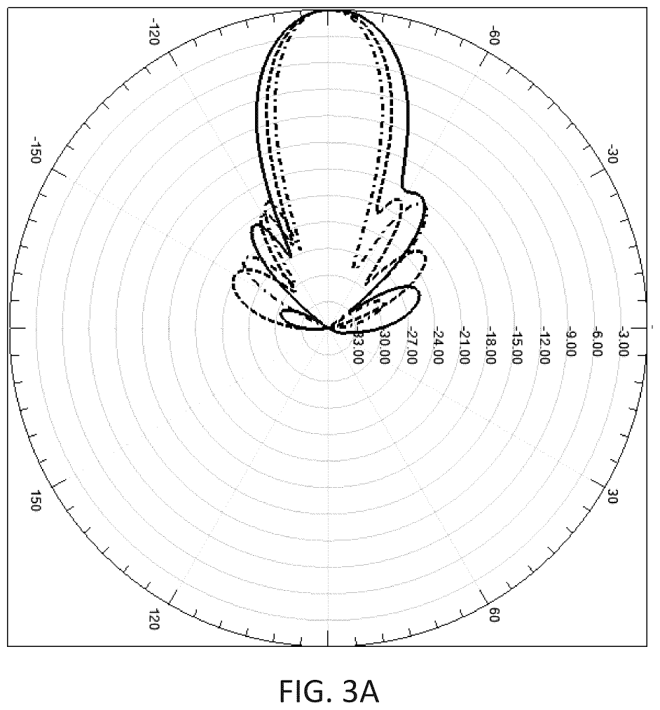

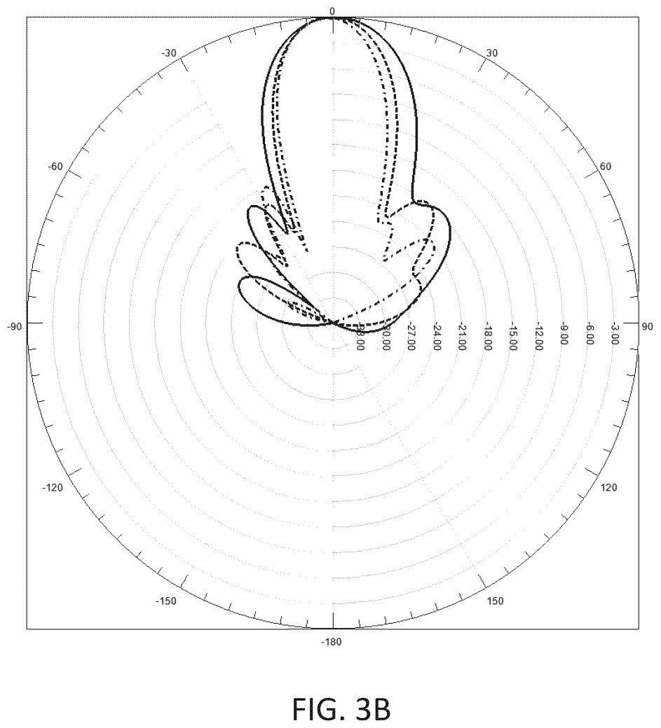

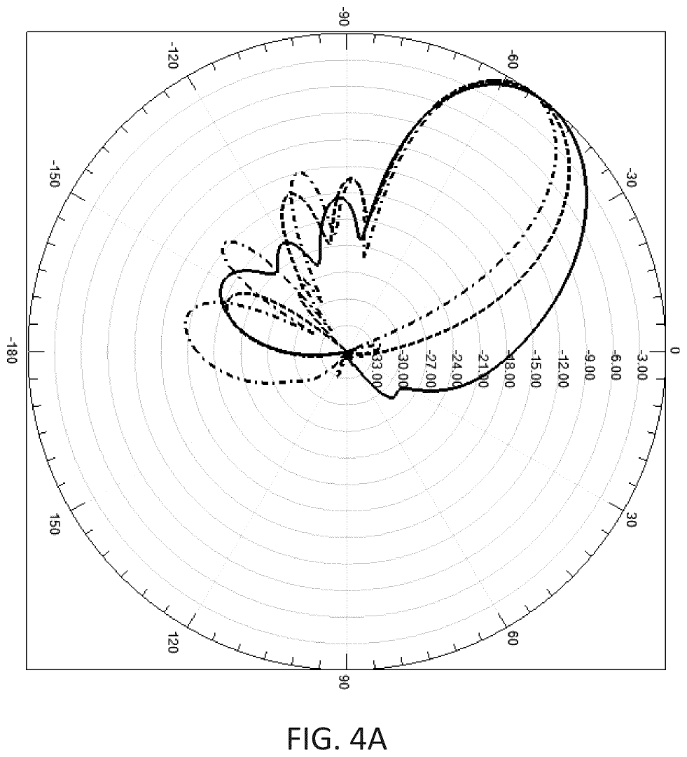

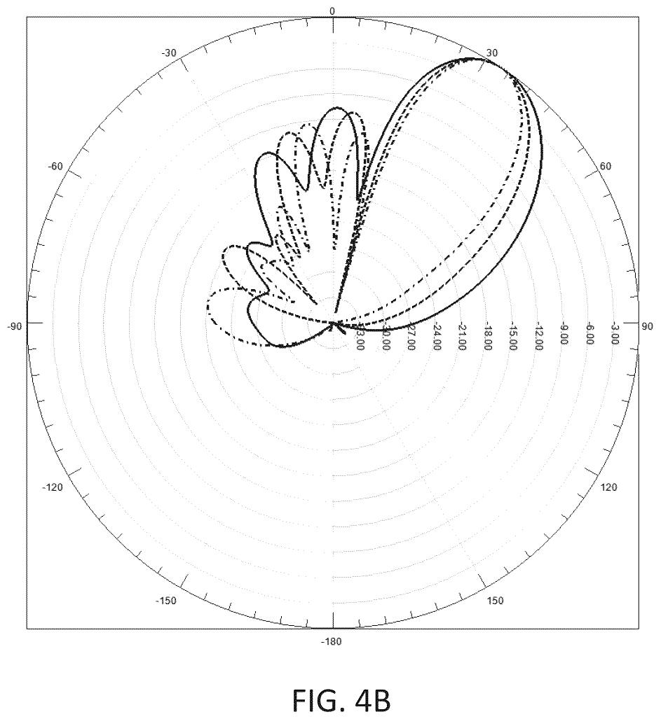

FIGS. 2A, 2B, 3A, 3B, 4A, and 4B show beam squint simulation results for a 3×7 Blass matrix (i.e., 7 elements in the azimuth) for a beam cross-over of 8 dB and a sector coverage of 120 degrees, using both a conventional Blass matrix and a Blass matrix according to the present disclosure (i.e., with the center beam assigned to the lowest row of the matrix). FIGS. 2A and 2B show simulations for the negative-extreme beam (in this simulation, at −30), with FIG. 2A corresponding to a simulated conventional beam assignment and FIG. 2B corresponding to a simulation of beam assignments according to the present disclosure. Similarly, FIGS. 3A and 3B show simulations for a center beam (in this simulation, at 0), and FIGS. 4A and 4B show simulations for the positive extreme beam (in this simulation, at +30). Again, FIGS. 3A and 4A show results of simulations of the conventional beam assignment and FIGS. 3B and 4B show results of simulations of a beam assignment according to the present disclosure. As can be seen, the beam squint in FIG. 4A (the lowest row, corresponding to an extreme-azimuth beam according to the conventional assignment) is significantly worse than the beam squint in FIG. 4B (the lowest row, corresponding to the center-azimuth beam according to the present assignment method). Further, the beam squint difference between FIGS. 3A and 3B (the center rows of each matrix circuit) is less substantial than the difference between FIGS. 4A and 4B. Thus, it can be seen that assigning the center beam to the lowest row effectively reduces the overall beam squint of beams produced by the matrix circuit.

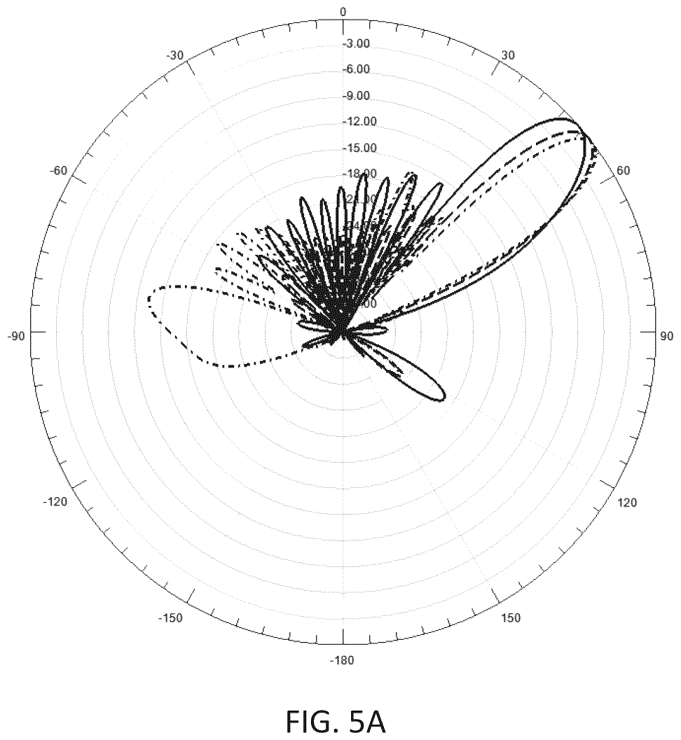

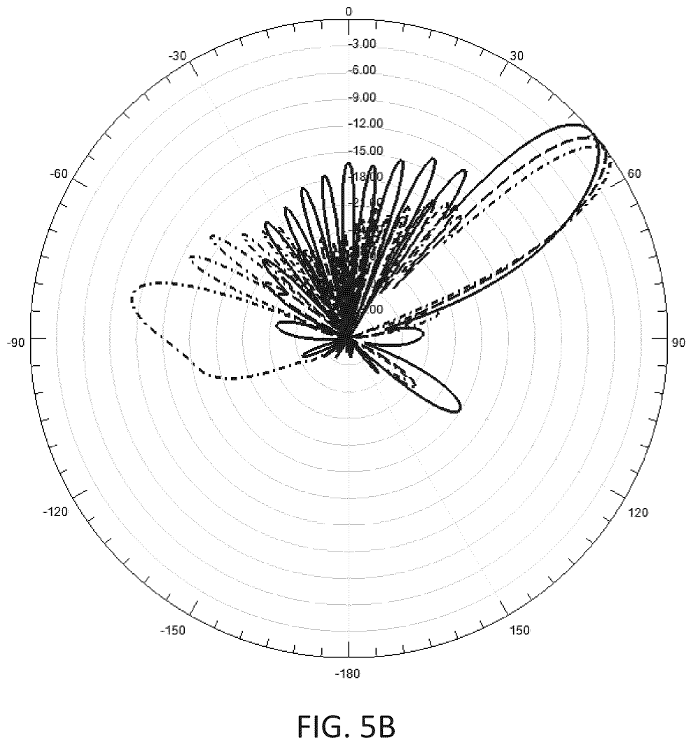

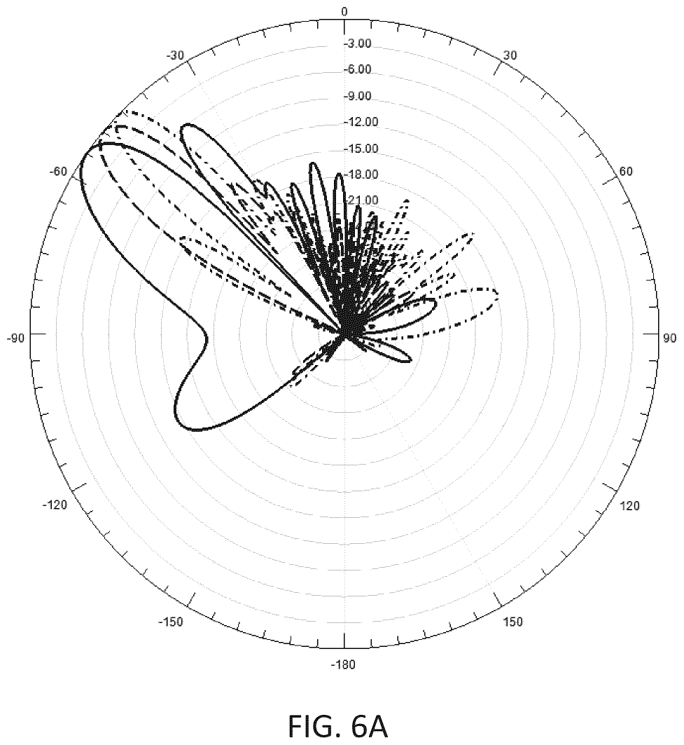

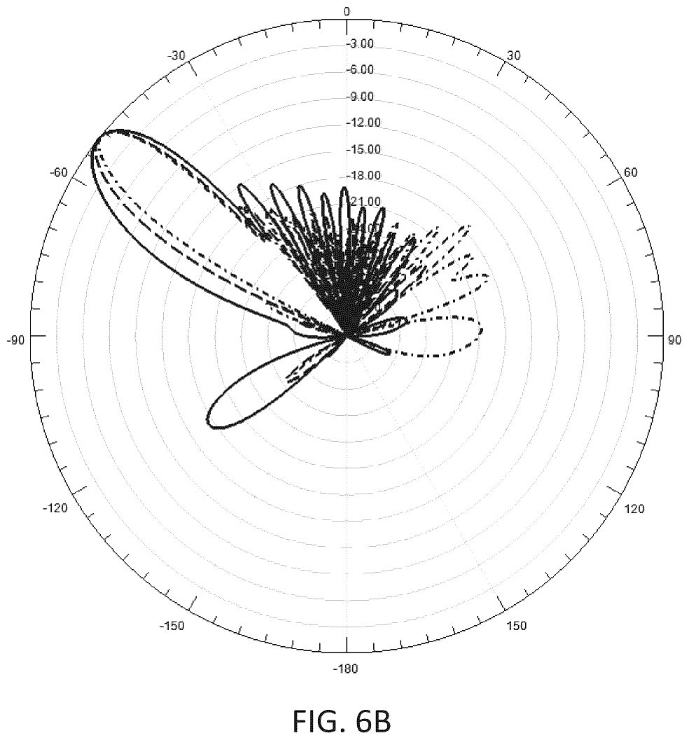

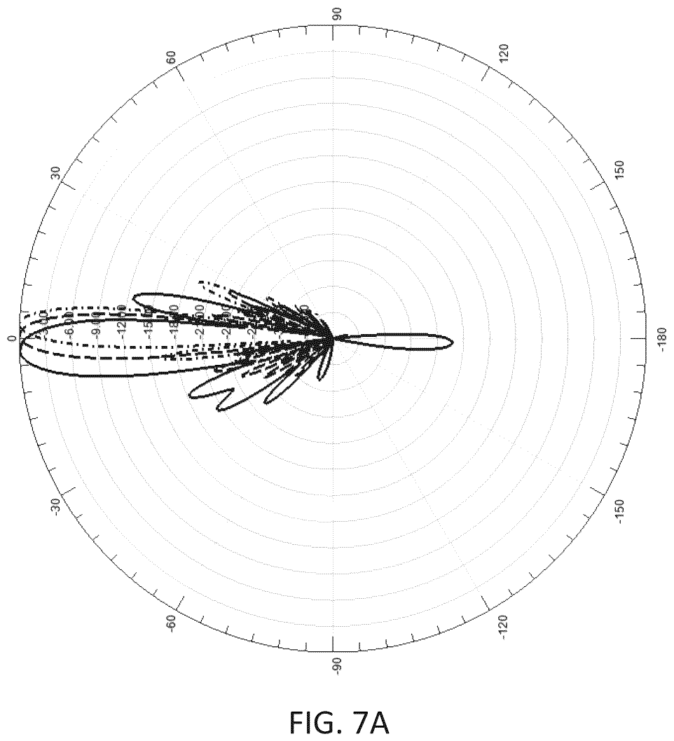

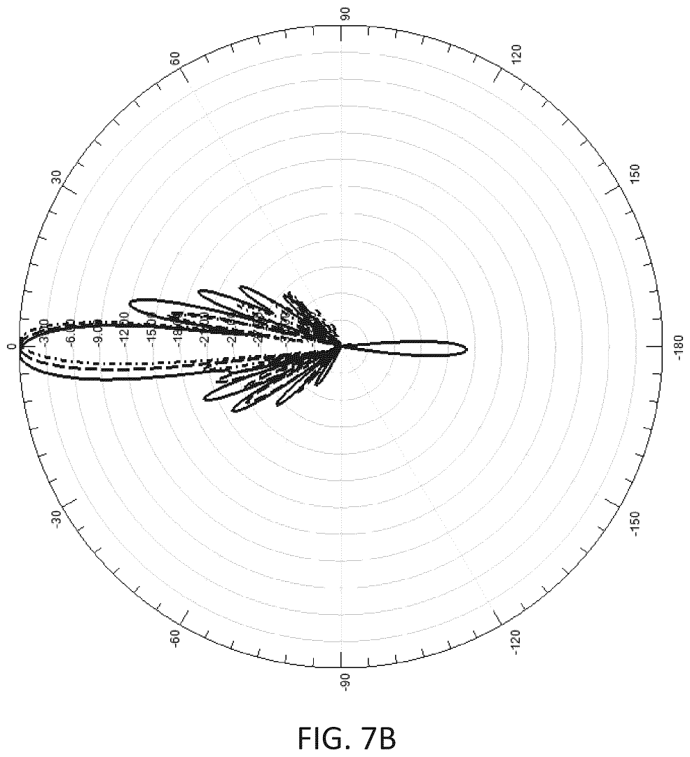

Similarly, FIGS. 5A, 5B, 6A, 7B, 7A, and 7B show beam squint simulation results for a 9×20 Blass matrix (i.e., 20 elements in the azimuth/9 beams), working over the frequency range of (1695-2690 MHZ) with azimuth beams located at (−52, −39, −26, −13, 0, +13, +26, +39, +52), using both a conventional Blass matrix and a Blass matrix as configured according to one aspect of the present invention (i.e., with the center beam assigned to the lowest row of the matrix). FIGS. 5A (conventional) and 5B (present assignment method) show simulations for the beam at +52 degrees, FIGS. 6A (conventional) and 6B (present assignment method) show simulations for the beam at −52 degrees, and FIGS. 7A (conventional) and 7B (present assignment method) show simulations for the beam at 0 degrees.

Again, with the conventional beam assignment method, there is still about an 8-degree beam squint for the beam located at −52 degrees, as can be seen in FIG. 6A. Moreover, the beam in this figure is clearly degraded and has a large side lobe. In contrast, the beam squint in FIG. 6B, applying the new method, is significantly reduced, and the beam quality is visibly better.

Further, as should be understood, the assignment of beams to the other rows of the matrix may be different in different embodiments. For example, in some embodiments, the extreme-azimuth beam is assigned to the center row of the matrix and no other beam assignments differ from the conventional assignment method. In other embodiments, multiple beam assignments differ from the conventional assignment method. For example, in some embodiments, the topmost two rows are assigned to provide the most extreme beams (positive and negative). In some such embodiments, moreover, the absolute value of the beam azimuth decreases for each successive pair of rows, until the last row of the matrix. Further, depending on the embodiment, either the left-most or right-most beam may be assigned to the center row.

As well as reducing beam squint, the various aspects of the present invention also provide more even gain between the different beams, when compared to conventional Blass matrices. Table 1 shows the gain of a Blass matrix over an azimuth range of (−52, −39, −26, −13, 0, +13, +26, +39, +56) using a conventional beam assignment method and using the modified beam assignment method.

TABLE 1

| | Gain of | |
|---|---|---|
| Blass beam | Conventional Blass | Gain of |
| direction (deg) | (dB) | Modified Blass (dB) |
| +52 | 22.8 | 22.7 |
| +39 | 23.2 | 23.2 |
| +26 | 23.0 | 23.1 |
| +13 | 22.9 | 22.8 |
| 0 | 22.5 | 22.2 |
| −13 | 22.2 | 21.9 |
| −26 | 22.3 | 22.2 |
| −39 | 22.0 | 22.5 |
| −52 | 21.1 | 22.1 |

As can be seen from Table 1, in the conventional Blass, the total gain difference across the azimuth range is 2.1 dB. However, the maximum difference in the modified matrix with the new row assignment is only 1.3 dB. That is, the new design provides more balanced gain between the different beams across the azimuth range.

Further, in some embodiments, phase compensation is applied in addition to the beam assignment method. This innovation involves mitigating the phase error introduced by each of the plurality of couplers. Ideally, the phase of each coupler is 90 degrees; however, when the coupling coefficient becomes larger than −3 dB, the coupler phase varies depending on the coupler coefficient. Therefore, phase compensation for each coupler is, in some embodiments, applied so that the phase of all the couplers becomes similar. This can be achieved by adding an extra phase factor on both the horizontal and the vertical lines that connect a coupler from one row to the next succeeding row.

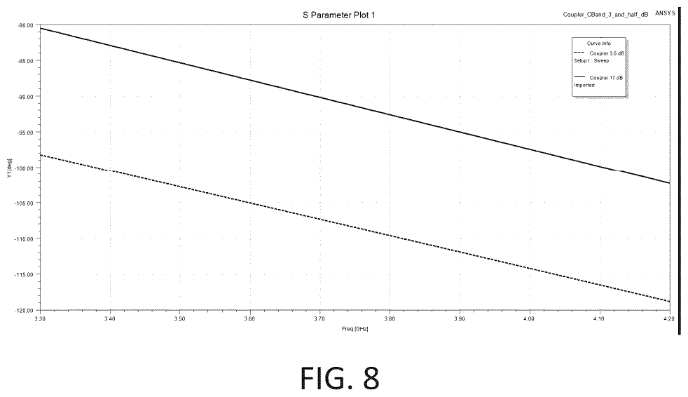

FIG. 8 shows the coupler phase difference. As shown in FIG. 8, there is a 17-degree difference when the coupler value is changed from 17 dB to 3.5 dB. To adjust for this difference, a transmission line with an electrical length of 17 degrees is, in some embodiments, added to a port (e.g., port 4) of each coupler. As well, an extra phase factor of 17 degrees is, in some embodiments, added to the delay line after each coupler. Of course, these values and this outlined approach are merely exemplary and should not be considered to limit the scope of the invention. The person skilled in the art would be aware of many suitable phase compensation approaches and would be able to select a suitable approach and suitable values for a specific implementation.

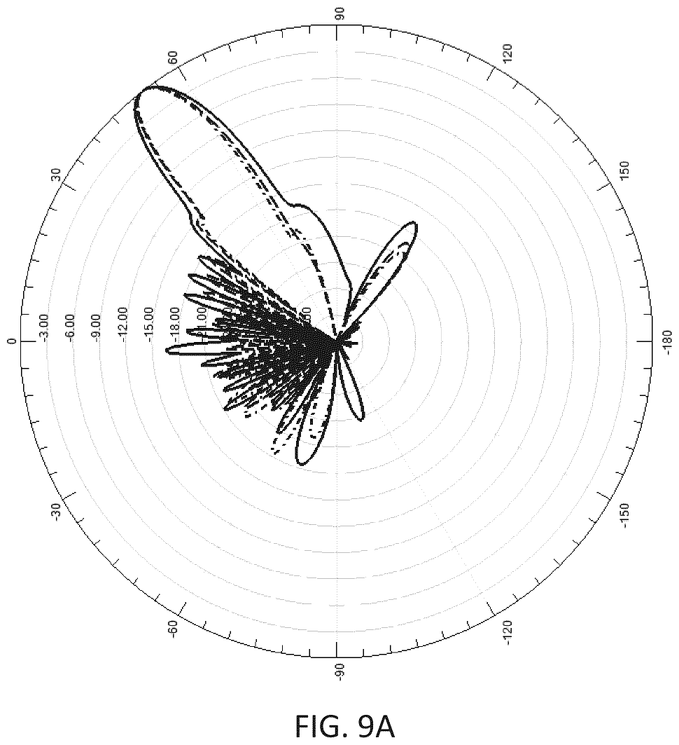

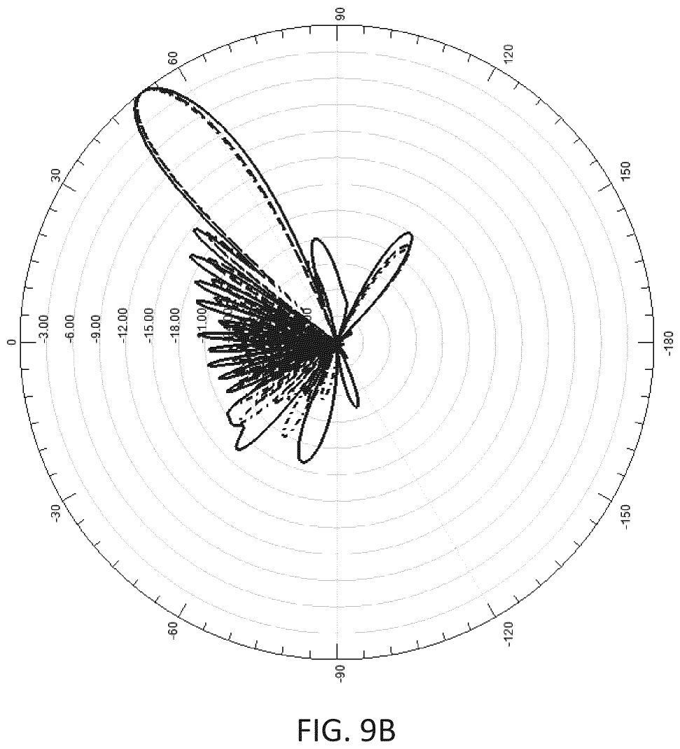

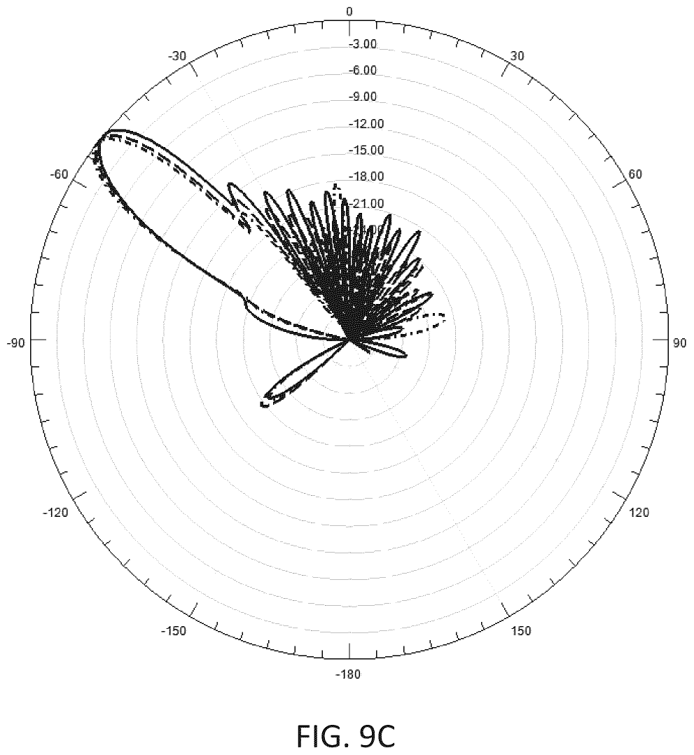

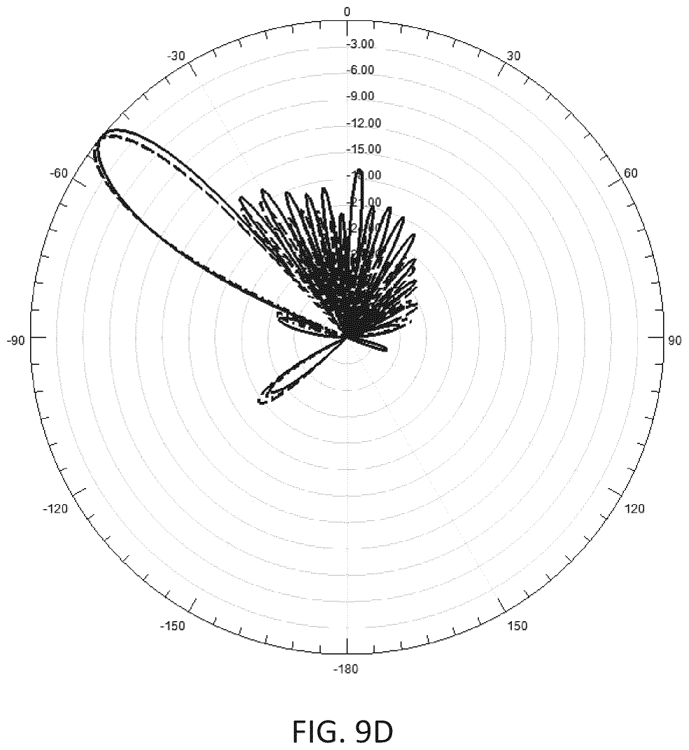

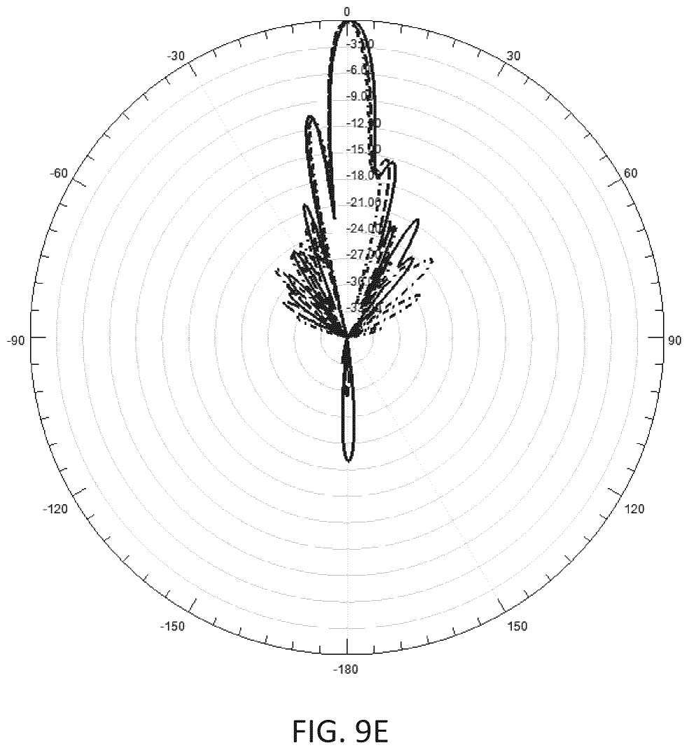

The effect of this phase compensation can be seen in FIGS. 9A, 9B, 9C, 9D, 9E, and 9F. FIGS. 9A (uncompensated) and 9B (compensated) show simulations for the beam at +52 degrees, FIGS. 9C (uncompensated) and 9D (compensated) show simulations for the beam at −52 degrees, and FIGS. 9E (uncompensated) and 9F (compensated) show simulations for the beam at 0 degrees. As can be seen, each of FIGS. 9B, 9D, and 9F show signals that are tighter (i.e., that have less squint) than their uncompensated counterparts.

It should be clear that, while the above discussion uses Blass matrix circuits as examples when discussing the various aspects of the present invention, these aspects of the present invention are equally applicable to other matrix circuits such as the Blass matrix circuit, the modified Blass matrix circuit, the Nolen matrix circuit and the modified Nolen matrix circuit.

As noted above, a Blass matrix was used in the examples and explanations provided above. As is well-known, another matrix circuit which may be used for MBFN purposes is the Nolen matrix. Compared to a Blass matrix, a Nolen matrix needs a lesser number of couplers and delay lines. Also, unlike a Blass matrix, a Nolen matrix does not contain resistors at the end of each row, which leads to cost and size reduction of the board. However, the conventional Nolen matrix has a number of issues (much like a Blass matrix) such beam squint and high sidelobe level (SLL). Moreover, the operating frequency range is narrow (narrowband) for a Nolen matrix.

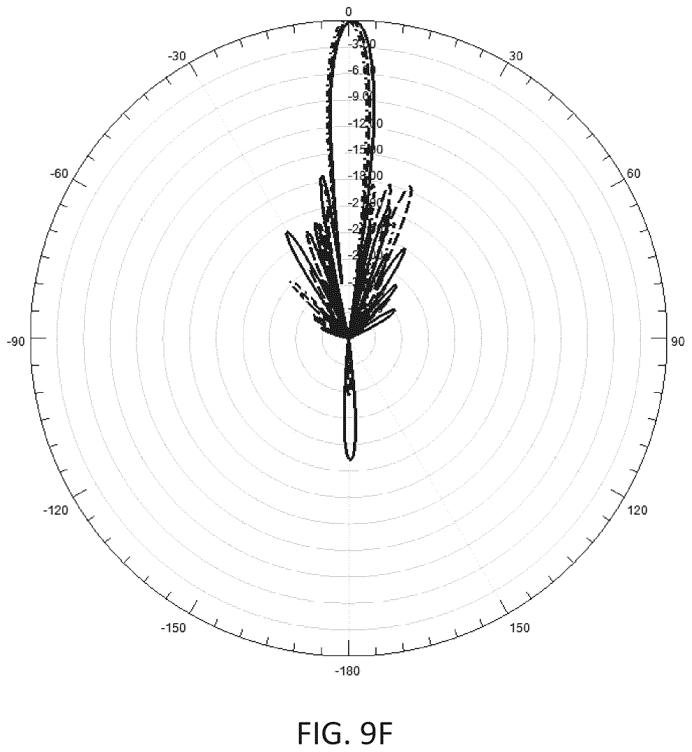

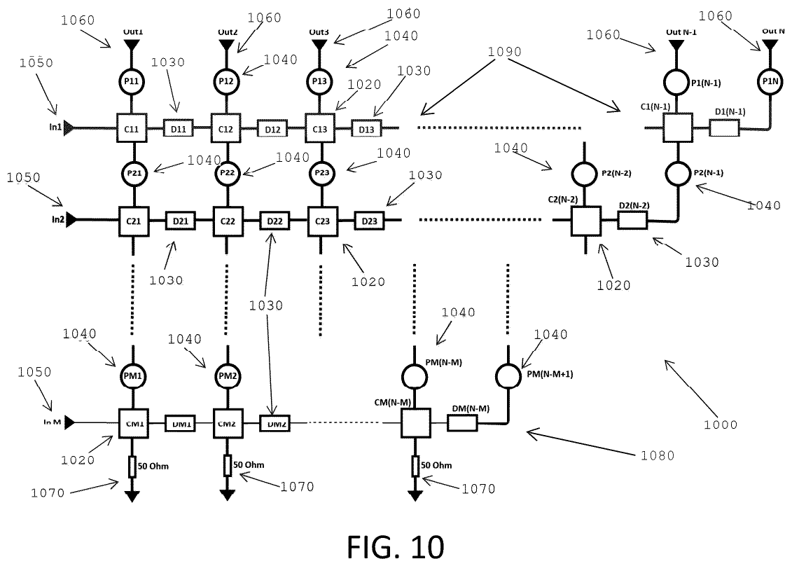

Referring to FIG. 10, a schematic diagram of a conventional Nolen matrix is illustrated. As is known, a conventional Nolen matrix consists of different components such as directional couplers, phase delay lines and so on. The Nolen matrix in FIG. 10 has M inputs (input signal beams) and N outputs (antenna outputs/antenna elements).

As can be seen in FIG. 10, the Nolen matrix 1000 has a number of columns and rows with couplers 1020, horizontal phase delay lines 1030, and vertical circuit element lines 1040. The Nolen matrix couples the input signal beams 1050 to the output antenna elements 1060 through the various couplers, phase delay lines, and circuit element lines. It should be clear that each column of the Nolen matrix has a collection of couplers and circuit element lines between an output antenna element and a load 1070. It should also be clear that the lowest row of the Nolen matrix is the row 1080 that is most adjacent the loads 1070 (and most adjacent to ground) while the highest row of the Nolen matrix is the row 1090 that is most adjacent to the output antenna elements 1060.

For greater clarity, in FIG. 10, the couplers are shown in squares denoted with a “C”, the horizontal phase delay lines are shown in rectangles denoted with a “D”, and the vertical circuit element lines are shown in circles denoted with a “P”. The coupling factors and phase delay lines are calculated using software. It should be noted that, in a conventional Nolen matrix, there are some phase errors which degrades the performance of the matrix.

For Nolen matrices, as with other matrix circuits and as noted above, beam squint is due to the phase shift from the matrix circuit rows and the azimuth angle of the beam.

And as noted above, the beams that are more inclined to extreme angles have inherently more squint. For example, the beam pointing to zero angle (without any azimuth tilt) has inherently less squint compared to a beam located at +/−30.

Mitigating beam squint is addressed above by the judicious assignment of input beams to specific rows in the matrix circuit.

Another factor to be improved upon is the sidelobe level (SLL). For every antenna array, there is a main beam (which is the desired beam), and sidelobes (which are unwanted). The two main factors which have the most impact on the sidelobes are the tapering (i.e. the power which goes to every antenna element), and the phase of each antenna element. The tapering is controlled by the couplers' coupling factors. However, the phase, as discussed above, is exposed to errors. Fixing the phase error problem will result in better SLL.

One solution to fixing the phase error problem is to determine the phase error for a particular antenna element and then to compensate for this phase error by using engineered/designed vertical circuit element lines between the various rows (for one specific column). The various vertical circuit element lines between the rows would introduce phase shifts that compensate for the phase error.

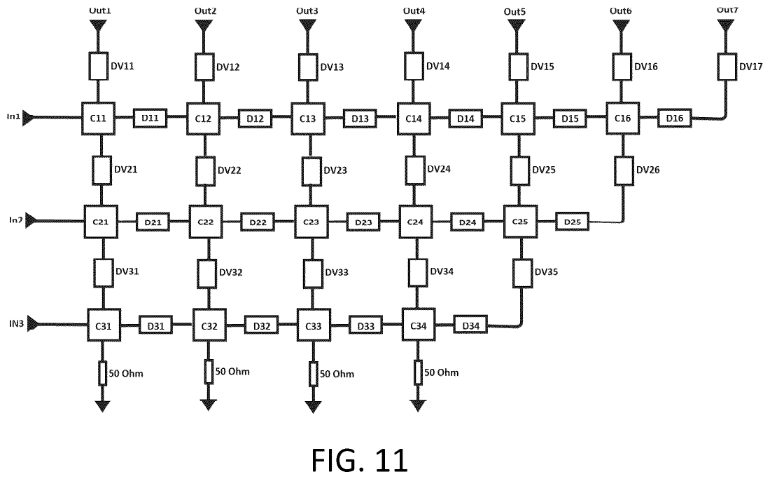

In one aspect of the present invention, only transmission lines are used between the output of each row to the input of the next row. The lengths of transmission lines are optimized in a way to create desired different phases, to compensate for the phase errors that occur at the input of the antenna elements (i.e. the output of the Nolen matrix). A sample 3-beam input, 7-elements output structure was designed using this innovation and this is illustrated in FIG. 11.

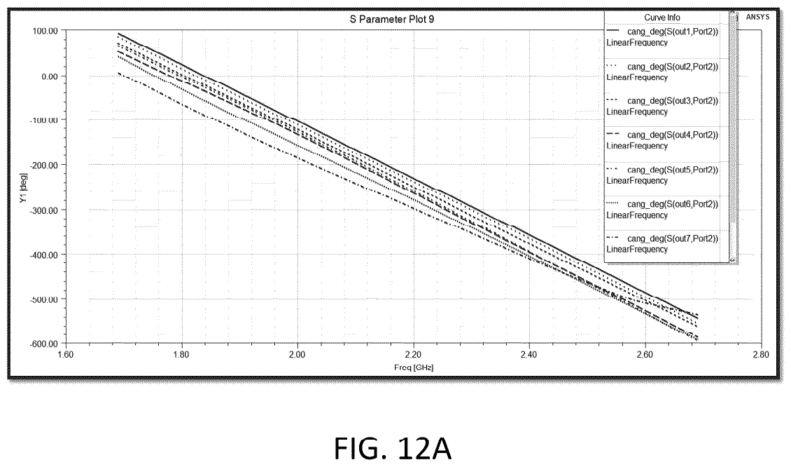

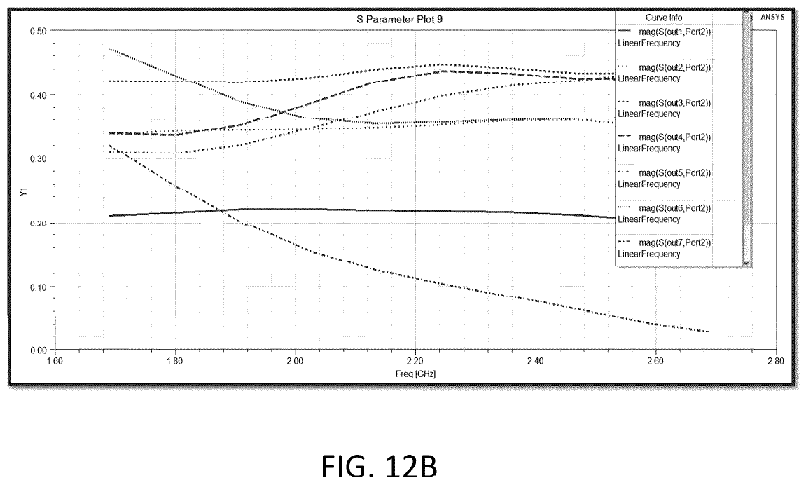

In FIG. 11, the vertical phase delay lines (shown in rectangles with “DVnm”) are optimized to compensate for the phase error so that the beam squint cancels and SLL improves. In addition, some couplers are optimized and adjusted in order to optimize the tapering at the input of the antenna elements. The phase and tapering for the middle beam (beam 2) are shown in FIG. 12A and FIG. 12B.

FIG. 12A shows the phase of beam 2 at the input of the antenna elements (output of Nolen matrix) without phase compensation. FIG. 12B shows the amplitude of beam 2 at the input of the antenna elements (output of Nolen matrix in FIG. 11) without phase compensation.

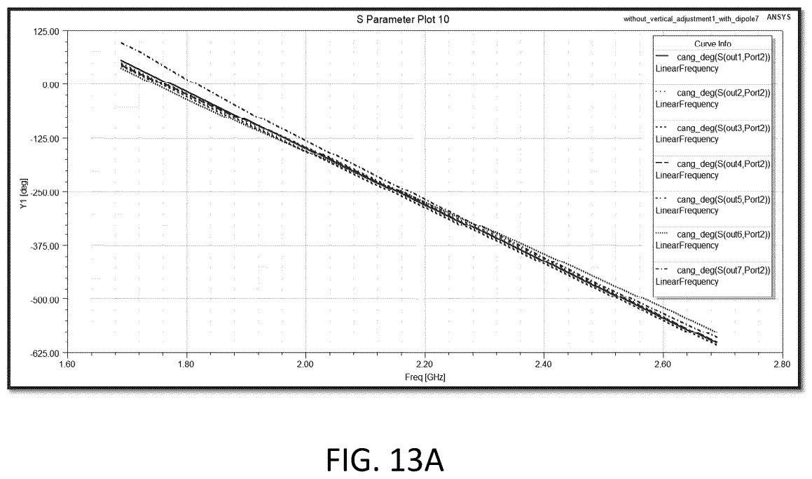

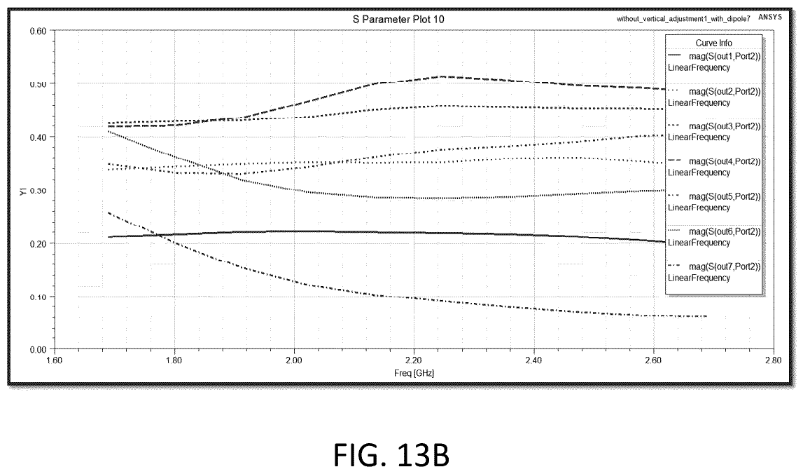

To contrast the effect of phase compensation, FIG. 13A and FIG. 13B are provided. FIG. 13A shows the phase of beam 2 at the input of the antenna elements (output of Nolen matrix) with phase compensation. FIG. 13B shows the amplitude of beam 2 at the input of the antenna elements (output of Nolen matrix) with phase compensation.

As shown in the figures, the phase and amplitude of the beam are optimized and adjusted so that performance improves in terms of both beam squint and SLL. As we have more degrees of freedom in this method (by adding different and optimized vertical transmission lines), the new Nolen matrix (shown in FIG. 11) operates in a wide range of frequencies 1695-2690 MHZ (wideband). The new Nolen matrix should also operate in other frequencies as well. These improvements are equally applicable to other matrix circuits such as the Blass matrix circuit, the modified Blass matrix circuit, the Nolen matrix circuit, and the modified Nolen matrix circuit.

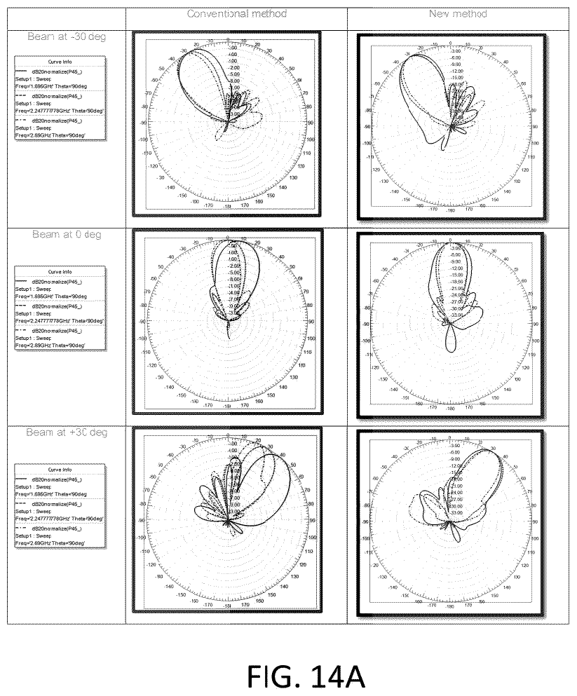

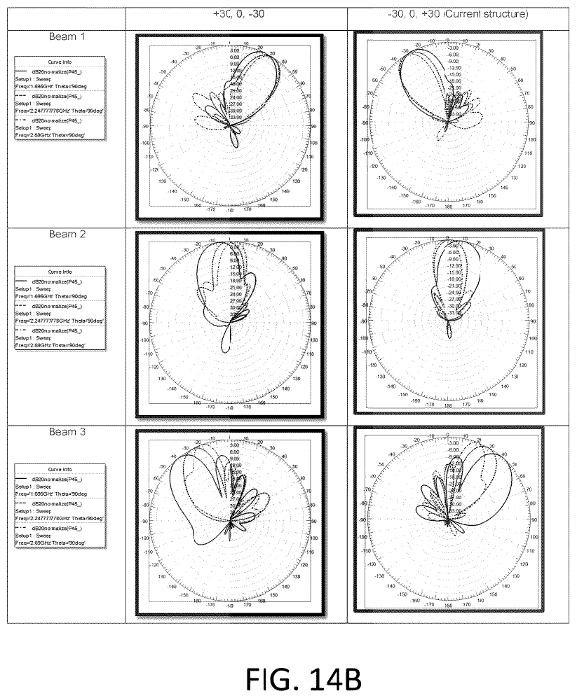

Referring to FIG. 14A, a comparison of beams using the phase compensation scheme and a conventional Nolen matrix is shown in the figure. As can be seen, the beams produced by the new method are improved in terms of beam squint, SLL, and frequency range (operating in the range of mid-band 1695-2690 MHz).

As noted above, the order of input signal beams assigned to the rows in the matrix can be adjusted. For a conventional three beam configuration (with beams at +30, 0, and −30 degrees), the conventional wisdom is to place the highest azimuth angle beam at the top row, i.e. +30, 0, −30, such that the zero-azimuth angle beam is in the middle row while the −30 azimuth angle input beam is at the bottom row. For this aspect of the invention, the order maybe that of: −30, 0, +30. Thus, the zero-azimuth angle beam is still in the middle row while the −30 degree azimuth angle beam is at the top row while the +30 azimuth angle beam is at the bottom row. FIG. 14B shows a comparison of the beams with this configuration with beams with a more conventional configuration. This novel configuration can reduce overall phase error.

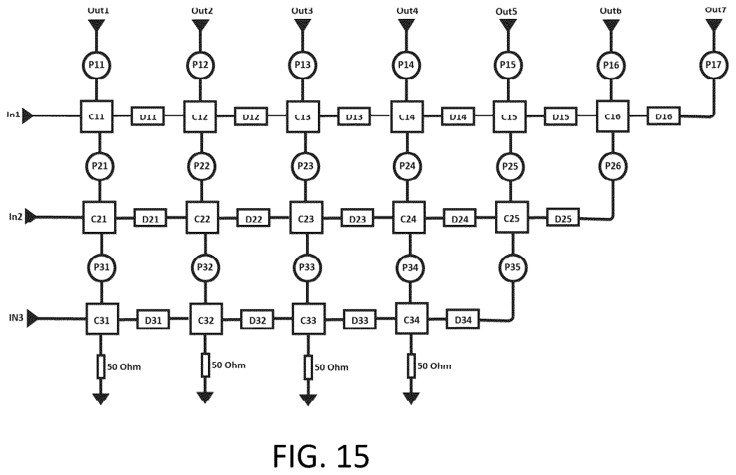

Another solution to the issue of beam squint and SLL is to use phase shifters instead of vertical phase delay lines between any two rows. For this innovation, a 3-beam input, 7-element output Nolen matrix configuration was designed and the block diagram for this configuration is presented in FIG. 15.

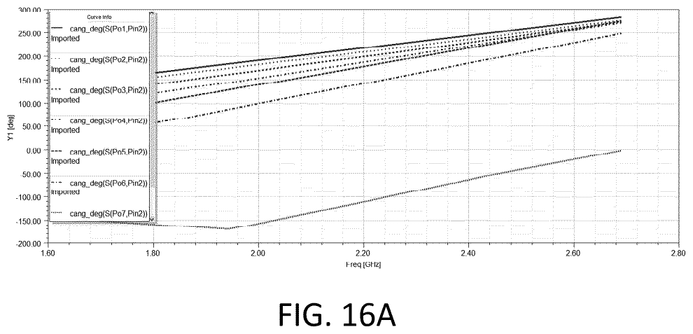

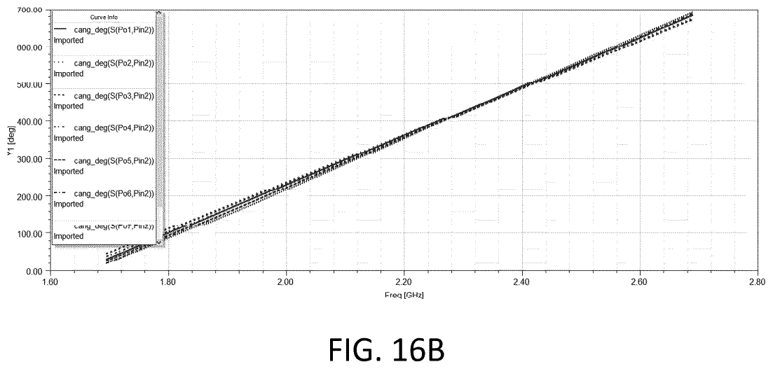

As a variant to the above, instead of using a single-phase shifter between adjacent rows, several cascaded phase shifters are used between adjacent rows (i.e., instead of the circular “Pmn” blocks in FIG. 15, there would be two or more phase shifters per pair of rows) in order to compensate for the phase error of the network. Similar to the above innovation, by adding the cascaded phase shifters, the beam squint cancels and the SLL improves compared to the conventional matrix. As an example of results obtained by using cascaded phase shifters between rows, the phase of the middle beam (beam 2) is shown in FIG. 16A and FIG. 16B. FIG. 16A shows the phase of the middle beam (beam 2) at the input of the antenna elements (i.e. at the output of the Nolen matrix) without compensation. FIG. 16B shows the phase of the middle beam (beam 2) at the input of the antenna elements (i.e. at the output of the Nolen matrix) with compensation.

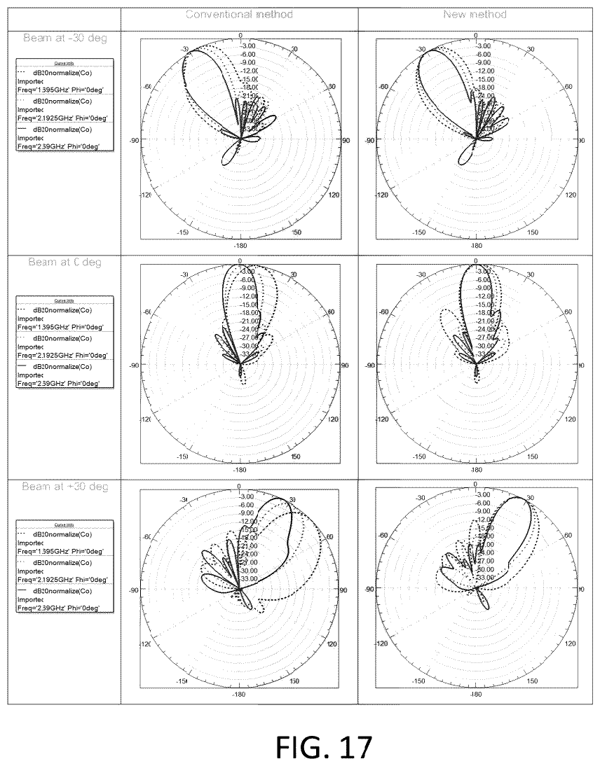

Referring to FIG. 17, shown is a comparison of beams for the scheme that uses phase shifters to compensate for phase errors and for a conventional Nolen matrix. As can be seen, the beam squint problem is fixed, the average SLL is improved, and the Nolen matrix performs well in wideband frequency range of 1695-2690 MHz.

As noted above, compared to the conventional Nolen matrix, the innovations detailed above provides for a modified Nolen matrix that has no beam squint, the SLL is improved, and the matrix works in a wider frequency band, covering the whole mid-band frequency range. It should also be noted that, while only the results for mid-band frequencies (1695-2690 MHZ) are detailed in this document, the innovations detailed also work for other frequencies such as low band, C-band, etc.

Referring to the circuits in FIG. 11 and FIG. 15, these designs produced two different Nolen matrices with two different approaches. The designs each have 3 inputs which give 3 beams with different directions. The resulting matrices have 7 outputs which are connected to 7 antenna array elements. The coupler values and horizontal delay line phase numbers are obtained using theoretical methods using appropriate software. Essentially, the phase errors to be compensated for are measured/calculated and the compensating phase shift is designed into the relevant delay line and/or phase shifter/cascaded phase shifter. As noted above, the vertical phase delay lines and phase shifters are optimally designed in such a way that they compensate for the phase error.

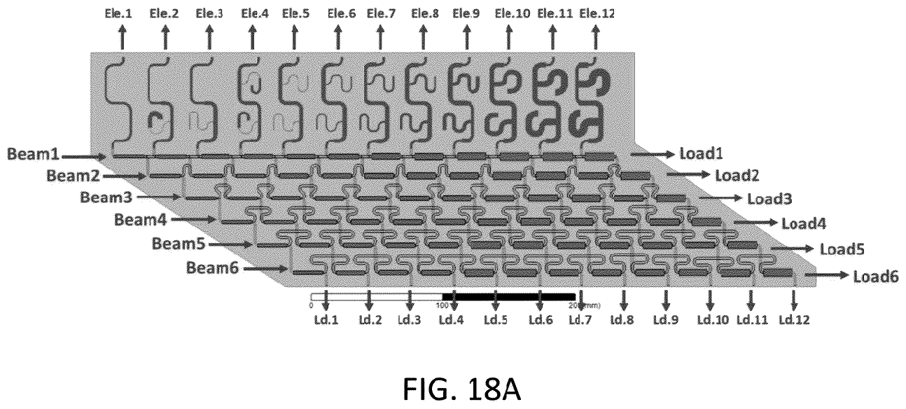

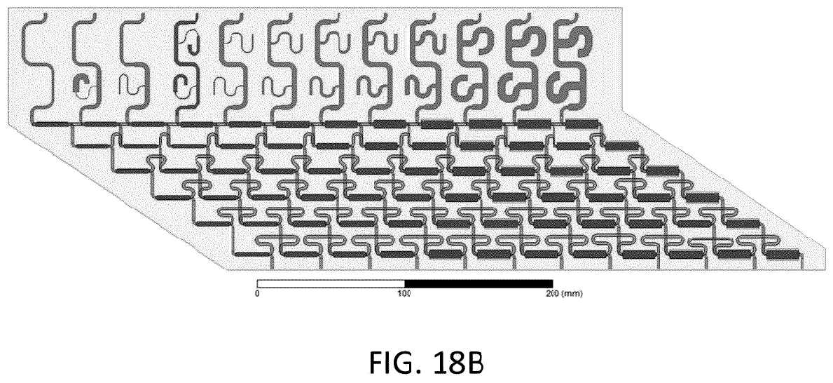

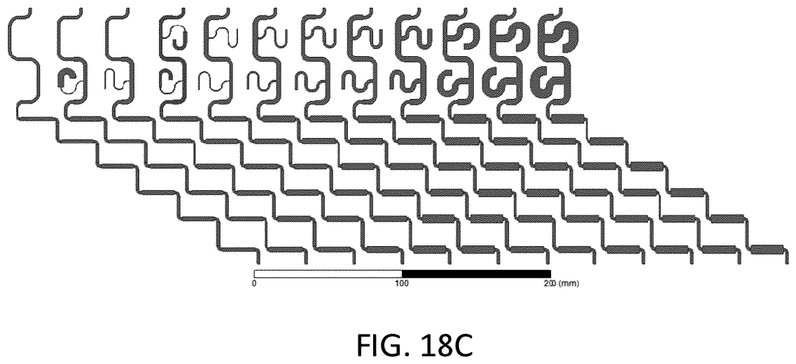

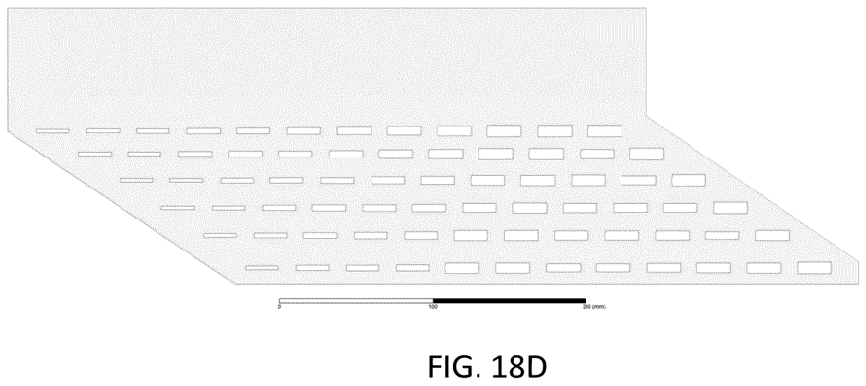

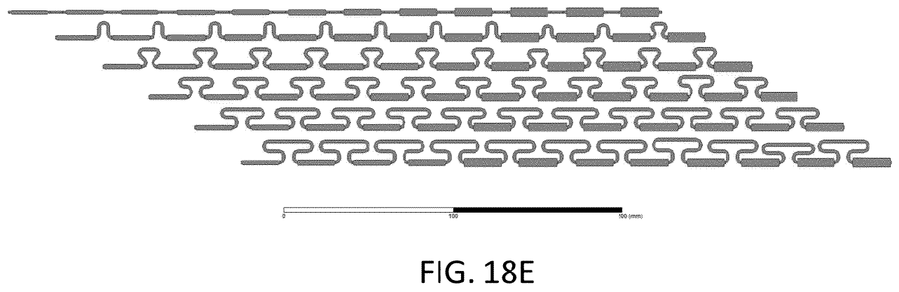

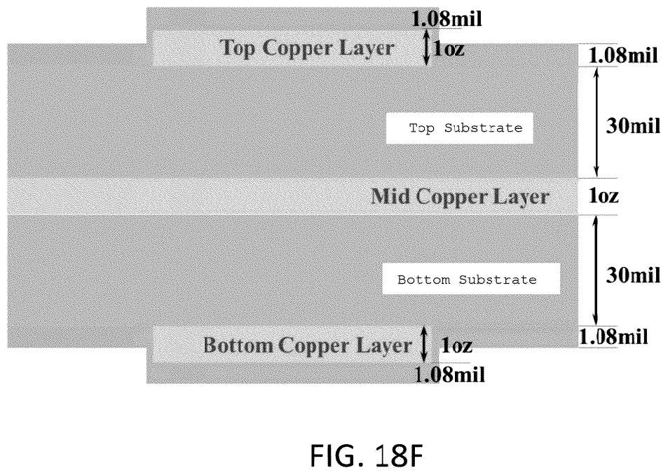

In terms of implementation, the various types of matrix circuits discussed above may be implemented using a multilayer board configuration. Referring to FIGS. 18A-18F, illustrated is a configuration according to such a multilayer configuration. For the configuration illustrated in the figures, illustrated is a 12-element 6-beam MBFN without beam squint. The overall configuration, positions of ports and loads, layouts of each layer, and the cross-section view of the example is shown in FIGS. 18A-18F. FIG. 18A shows the overall configuration of the system detailing the definitions of the beam ports, element ports, and loads. As can be seen from FIG. 18A, implemented is a Blass matrix using a 3-layer configuration, with a top layer, a middle layer, and a bottom layer. In between the top, middle, and bottom layers are substrate layers. FIG. 18B is a top view of the copper layers for the system in one diagram. FIG. 18C is the bottom layer layout, FIG. 18D is the middle layer layout (a “mask” with cutout regions or holes to allow the traces on the top and bottom layers to couple to one another), and FIG. 18E is the top layer layout. FIG. 18F is a cross-sectional view of the resulting circuit board for this implementation, detailing the top, middle, and bottom layers as well as the substrate layers.

From FIGS. 18A-18F, it can be seen that the matrix of couplers and the meander lines located in between the couplers form the Blass matrix. As well, it can be seen that the 12 bent lines with bent open-end stubs on the upper side of FIG. 18C form a phase-shifter group that would be adjacent the inputs to an antenna array. In one implementation, this example configuration was operated within the frequency band of 1.695 GHz-2.69 GHz. This phase shifter group, as implemented, would operate to reduce or cancel the beam squint. Of course, the various methods detailed above for the various types of matrix circuits can be implemented with the implementation method detailed here. The phase shifter group illustrated in FIG. 18C can be removed and other methods to cancel/reduce beam squint (as detailed above) can be used. Similarly, with or without the phase shifter group in the matrix circuit, the other methods for adjusting/compensating for phase error can also be applied/implemented using the implementation method detailed here.

For clarity, the configuration in FIGS. 18A-18F uses a single row of phase shifters and these phase shifters are placed outside the Blass matrix to cancel the beam squint. The matrix circuit can be implemented without the phase shifter group and the various aspects of the present invention can be implemented with the configuration devoid of the phase shifter group.

It should be clear that the implementation method detailed in FIGS. 18A-18F is also applicable to other matrix circuit types. The implementation method detailed in this document can be applied to Blass matrix circuits, modified Blass matrix circuits, Nolen matrix circuits, and modified Nolen matrix circuits.

As another way to achieve better beam characteristics from the beams resulting from the matrix circuit, the holes or voids in the middle layer as well as the circuit traces on one or both of the top and bottom layers can be adjusted in terms of size, shape, and configuration. The holes can have non-parallel sides and the traces can also have a non-parallel based shape. Similarly, the shapes of the holes and traces can be non-conventional/non-regular. Such methods can be used to produce suitable matrix circuits using a multilayer configuration to produce beams with suitable characteristics.

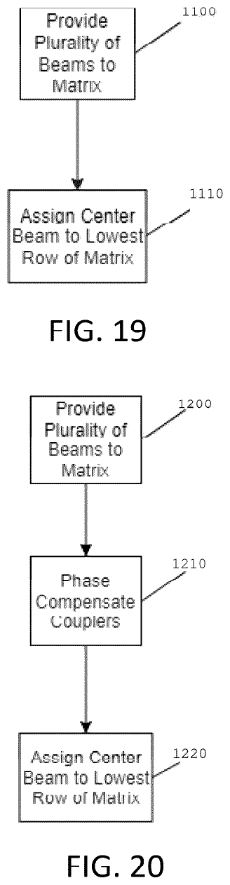

FIG. 19 is a flowchart detailing a method according to one aspect of the invention. At step 1100, a plurality of signal beams is provided to a matrix circuit. At step 1110, the center beam (i.e., the one of the plurality of signal beams that has the least absolute azimuthal tilt) is assigned to the bottom row of the matrix circuit. This mitigates beam squint and helps to balance gain between the beams, as detailed above.

FIG. 20 is another flowchart detailing a method according to an embodiment of the invention. Again, at step 1200, a plurality of signal beams are provided to a matrix circuit. At step 1210, phase compensation is applied to the couplers comprising the matrix circuit. At step 1220, the center beam is assigned to the bottom row of the matrix circuit.

It should be noted that steps 1200 and 1210 in FIG. 20 may, in some embodiments, be reversed. That is, the order in which phase compensation is applied to the couplers and the beams are provided to the matrix depends on the implementation and should not be considered as limiting the scope of the invention.

A person understanding this invention may now conceive of alternative structures and embodiments or variations of the above all of which are intended to fall within the scope of the invention as defined in the claims that follow.

What is claimed is:

1. A matrix circuit for coupling a plurality of input signal beams to a plurality of output antennas in an antenna array, the matrix circuit comprising:
a matrix of couplers, horizontal phase delay lines, and vertical circuit element lines;
wherein said matrix is configured to form:
a plurality of rows of circuit elements, each row of circuit elements comprising couplers and horizontal phase delay lines, each row receiving an input signal beam and each row comprising couplers coupled in series with at least one horizontal delay line between each pair of adjacent couplers; and
a plurality of columns of circuit elements, each column of circuit elements comprising couplers and vertical circuit element lines, said couplers being coupled in series with at least one vertical circuit element line between each pair of adjacent couplers, each column being coupled between an output antenna and ground;
wherein
at least one column of circuit elements further comprises a load coupled between a coupler and ground;
an output of each column of circuit elements is received by an output antenna element;
said matrix circuit is for forming multiple output beams based on said input signal beams.

2. The matrix circuit according to claim 1, wherein at least one row of circuit elements is coupled between an input signal beam and a load.

3. The matrix circuit according to claim 1, wherein each coupler is one of: a directional coupler and a hybrid coupler.

4. The matrix circuit according to claim 1, wherein phase compensation is applied to at least one of said couplers.

5. The circuit according to claim 1, wherein each row of said matrix circuit provides a distinct signal beam having a unique azimuth within a predetermined azimuth range, such that at least three distinct signal beams are provided by said antenna array, said at least three distinct signal beams comprising at least a negative-extreme-azimuth beam corresponding to a negative extreme of said azimuth range, a center azimuth beam corresponding to a center of said azimuth range, and a positive-extreme-azimuth beam corresponding to a positive extreme of said azimuth range,
wherein
said center azimuth beam is provided to a bottom row of said matrix circuit.

6. The matrix circuit according to claim 5, wherein a center row of said matrix circuit is provided with one of: said negative-extreme-azimuth beam and said positive-extreme-azimuth beam.

7. The matrix circuit according to claim 5, wherein bottom rows of said matrix circuit are assigned with beams having highest directivity.

8. The matrix circuit according to claim 1, wherein a cumulative effect of characteristics of said vertical circuit elements for each column is to compensate for a phase error at an input to an output antenna element.

9. The matrix circuit according to claim 8, wherein said vertical circuit elements are phase shifters.

10. The matrix circuit according to claim 8, wherein said vertical circuit elements are vertical phase delay lines.

11. The matrix circuit according to claim 9, wherein said vertical circuit elements are cascaded phase shifters.

12. A method for improving beam characteristics of beams produced by an antenna array fed by a multibeam forming network (MBFN), the method comprising:
a) providing a matrix circuit of rows and columns of circuit elements to operate as said multibeam forming network;
b) providing input signal beams to said matrix circuit such that specific input signal beams are assigned as input to specific rows of circuit elements in said matrix circuit;
c) executing at least one of:
c1) assigning a specific input signal beam from said input signal beams to a specific row in said matrix circuit, said specific input signal beam having a lowest absolute value azimuth angle among said input signal beams and said specific row being a row most adjacent to ground;
c2) configuring at least one specific column in said matrix circuit to compensate for errors in antenna outputs for said at least one specific column;
wherein said matrix circuit comprises:
a plurality of rows of circuit elements, each row of circuit elements comprising couplers and horizontal phase delay lines, each row receiving an input signal beam and each row comprising couplers coupled in series row-wise with at least one horizontal delay line between each pair of adjacent couplers; and
a plurality of columns of circuit elements, each column of circuit elements comprising couplers and vertical circuit element lines, said couplers being coupled in series column-wise with at least one vertical circuit element line between each pair of adjacent couplers, each column being coupled between an output antenna and ground.

13. The method according to claim 12, wherein, for step c1), said specific input signal beam is a center azimuth beam.

14. The method according to claim 12, wherein step c1) comprises assigning an input signal beam having a highest absolute value azimuth angle to a row of said matrix circuit that is most adjacent to output antennas to which said matrix circuit is coupled.

15. The method according to claim 12, wherein each row of said matrix circuit receives a distinct input signal beam having a unique azimuth within a predetermined azimuth range, such that at least three distinct input signal beams are received by said matrix circuit, said at least three distinct signal beams comprising at least a negative-extreme-azimuth beam corresponding to a negative extreme of said azimuth range, a center azimuth beam corresponding to a center of said azimuth range, and a positive-extreme-azimuth beam corresponding to a positive extreme of said azimuth range, and
wherein said specific input signal beam in step c1) is said center azimuth beam.

16. The method according to claim 15, wherein step c1) further comprises providing said negative-extreme-azimuth beam to a center row of said matrix circuit.

17. The method according to claim 15, wherein step c1) further comprises providing said positive-extreme-azimuth beam to a center row of said matrix circuit.

18. The method according to claim 15, wherein step c1) further comprises providing said negative-extreme-azimuth beam and said positive-extreme-azimuth beam to a first and second top two rows of said matrix circuit.

19. The method according to claim 12, wherein step c1) further comprises assigning said rows to signal beams such that each matrix row is adjacent another matrix row receiving an opposite azimuth value, said opposite azimuth value being a same absolute value and an opposite sign.

20. The method according to claim 12, wherein step c2) comprises configuring said at least one specific column such that a cumulative effect of characteristics of said vertical circuit elements for said at least one specific column compensates for a phase error at an input to an antenna element for said at least one specific column.

21. The method according to claim 20, wherein said vertical circuit elements are one of: phase shifters and vertical phase delay lines.

22. The method according to claim 21, said vertical phase delay lines are specific lengths of transmission lines such that a cumulative effect of said vertical phase delay lines is to compensate for said phase error.

23. The method according to claim 21, wherein said phase shifters are constructed and arranged to compensate for said phase error.

24. The method according to claim 21, wherein step c2) comprises calculating said phase error and adjusting characteristics of said phase shifters to compensate for said phase error.

25. The method according to claim 12, wherein said errors in antenna outputs for said at least one specific column is at least one of:
beam squint;
side lobe levels; and
phase errors.

26. The method according to claim 12, wherein said matrix circuit is used to generate beams for use in cellular applications.

27. The matrix circuit according to claim 1, wherein said matrix circuit is any one of a Nolen matrix, a Blass matrix, a modified Nolen matrix, and a modified Blass matrix.
